(19) United States
(12) Patent Application Publication
(10) Pub. No.: US 2019/0210546 A1
(43) Pub. Date: Jul. 11, 2019

(54) VEHICLE ROOF STRUTURE WITH INTEGRATED ELECTRICAL CONNECTIVITY MODULE AND METHODS FOR MAKING THE SAME

(71) Applicant: Byton Limited, Hong Kong (HK)

(72) Inventor: Shawn Slovesko, Santa, CA (US)

(21) Appl. No.: 15/863,789

(22) Filed: Jan. 5, 2018

(51) Int. Cl. B60R 16/023; B62D 25/06; B60J 7/043; B62D 65/04; H01Q 1/32

(52) U.S. Cl. CPC B60R 16/0239; B62D 25/06; B60J 7/043; B62D 27/023; B62D 65/04; H01Q 1/325; B60Y 2304/072; B60R 16/0231

(57) ABSTRACT

Vehicle roof structure with integrated electrical connectivity module and methods for making the same are disclosed. For one example, the vehicle roof structure includes a plurality of pre-assembled components and an electrical connectivity module. The pre-assembled components include a plastic panel which covers a first compartment integrated into the roof structure that houses the electrical connectivity module below the plastic panel. The electrical connectivity module can be coupled to an antenna system that provides radio or cellular communications. The antenna system can be attached to the plastic panel. The electrical module can include a plurality of modems that can receive and transmit radio or cellular signals. An advanced driver assistance systems (ADAS) module can be housed in a second compartment integrated into the roof structure. The roof structure including the electrical connectivity module or ADAS module can be attached to a body frame of a vehicle. The plastic panel protects the electrical connectivity module while not creating a barrier for radio or cellular communications of the antenna system. The roof structure can be an aluminum roof structure, a fixed full glass roof structure, a fixed half glass roof structure or a movable sun structure.

### FIELD

Embodiments of the invention are in the field of vehicles including electrical and self-driving automobiles and moving vehicles. More particularly, embodiments of the invention relate vehicle roof structures with integrated electrical connectivity module and methods for making the same.

### BACKGROUND

In general assembly of a vehicle, a body frame is assembled to a roof structure component by component or part by part. If there are different types of roof structures, e.g., one with a sun roof and one without a sun roof, the general assembly of the vehicle can create layers of complexity to accommodate for the different roof structures. In addition, roof structures may require electrical connectivity and wiring for an antenna system which requires a worker in the general assembly line to go be inside the body frame to attach the wiring and parts from the inside of the body of the vehicle.

### SUMMARY

Vehicle roof structure with integrated electrical connectivity module and methods for making the same are described. For one example, the vehicle roof structure includes a plurality of pre-assembled components and an electrical connectivity module. The pre-assembled components include a plastic panel which covers a first compartment integrated into the roof structure that houses the electrical connectivity module below the plastic panel. The electrical connectivity module can be coupled to an antenna system that provides radio or cellular communications. The antenna system can be attached to the plastic panel. The electrical module can include a plurality of modems that can receive and transmit radio frequency (RF), cellular, or other types of wireless signals.

For one example, an advanced driver assistance systems (ADAS) module can be housed in a second compartment integrated into the roof structure. The roof structure including the electrical connectivity module or ADAS module can be attached to a body frame of a vehicle. The plastic panel protects the electrical connectivity module while not creating a barrier for radio or cellular communications of the antenna system. For one example, the roof structure is an aluminum roof structure, a fixed full glass roof structure, a fixed half glass roof structure or a movable sun structure.

For one example, a vehicle assembly method is disclosed. A body frame for a vehicle is assembled. One or more electrical modules are integrated into pre-assembled roof structure parts defining one or more compartments to house the electrical modules. The pre-assembled roof structure parts with the electrical modules mounted therein are attached for form a roof structure. The roof structure is attached to the assembled body frame of the vehicle. The one or more electrical modules can be integrated into the pre-assembled roof structure parts independently of the assembly of the body frame for the vehicle. The one or more electrical modules can include an electrical connectivity module which can be integrated into a first compartment of the roof structure. An electrical module can also include an advanced driver assistance systems (ADAS) module which can be integrated into a second compartment of the roof structure. One of the pre-assembled parts can be a plastic panel with an antenna system integrated with plastic panel. The antenna system can be coupled to the electrical connectivity module in the roof structure.

Other vehicles, roof structures module and methods are described.

### BRIEF DESCRIPTION OF THE DRAWINGS

The appended drawings illustrate examples and are, therefore, exemplary embodiments and not considered to be limiting in scope.

FIGS. 1A-D illustrates exemplary roof structures with integrated compartments to house electrical modules.

FIG. 2A illustrates exemplary pre-assembled parts for an aluminum roof structure.

FIG. 2B illustrates one example of a top view of the aluminum roof structure of FIG. 2A attached to a body frame.

FIGS. 2C-2E illustrates one example of cross-sectional views taken along the lines C-C, A-A and B-B of the top view in FIG. 2B.

FIG. 3A illustrates exemplary pre-assembled parts for a fixed full glass roof structure.

FIG. 3B illustrates one example of a top view of the fixed full glass roof structure of FIG. 3A attached to a body frame.

FIGS. 3C-3D illustrates one example of cross-sectional views taken along the lines A-A and B-B of the top view in FIG. 3B.

FIG. 4A illustrates exemplary pre-assembled parts for a fixed half-glass roof structure.

FIG. 4B illustrates one example of a top view of the fixed half-glass roof structure of FIG. 4A attached to a body frame.

FIG. 4C illustrates one example of a cross-sectional view taken along the line A-A of the tope view in FIG. 4B.

FIG. 5A illustrates exemplary pre-assembled parts for a movable sun roof structure.

FIG. 5B illustrates one example of a top view of the movable sun roof structure of FIG. 5A attached to a body frame.

FIG. 5C illustrates one example of a cross-sectional view taken along the line A-A of the top view in FIG. 5B.

FIG. 6 illustrates one example of a vehicle showing a top view of a roof structure with an electrical connectivity module and an advanced driver assistance systems (ADAS) module integrated into the roof structure.

FIG. 7 illustrates one example of a flow diagram of a process for vehicle assembly.

FIG. 8 illustrates another example of pre-assembled parts for roof structure with a plastic panel in the front and back end of the roof structure.

### DETAILED DESCRIPTION

Vehicle roof structure with integrated electrical connectivity module and methods for making the same are described. Examples and embodiments of roof structures are described defining one or more compartments integrated into the roof structure to house electrical modules. The modules integrated into the roof structure can include an electrical connectivity module to couple with an antenna system providing radio frequency (RF), cellular, or other wireless communication capabilities. Another module can be an advanced driver assistance systems (ADAS) module to assist a driver in the driving process and can be configured to operate with a human-machine interface.

For one example, in manufacturing a vehicle, the roof structure can be assembled offline on a separate platform and separately from assembling the body frame of the vehicle. One or more electrical modules can be integrated into the roof structure offline from the assembly of the body frame. The roof structure with the integrated electrical modules can be attached to the body fame as one piece in the general assembly process of the vehicle thereby making the assembly process of the vehicle less complex. For instance, an operator need not be situated inside the body frame to assemble parts of the roof structure and perform calibration during the assembly of the vehicle. That is, the roof structure and body frame can be assembled separately and independently and attached to each later in the general assembly process.

For one example, the vehicle roof structure includes a plurality of pre-assembled components and an electrical connectivity module. The pre-assembled components include a plastic panel which covers a compartment integrated into the roof structure that houses the electrical connectivity module below the plastic panel. The electrical connectivity module can be coupled to an antenna system that provides radio frequency (RF), cellular or other wireless communications. The antenna system can be attached to the plastic panel. For one example, the electrical module can include a plurality of modems that can receive and transmit (RF), cellular or other types of wireless signals.

For one example, an ADAS module can be housed in the compartment integrated into the roof structure. The roof structure, including the electrical connectivity module or ADAS module, can be attached to a body frame of a vehicle. The plastic panel can protect the electrical connectivity module or ADAS module while not creating a barrier for RF, cellular or other wireless signals or communications related to the antenna system. For one example, the roof structure can be an aluminum roof structure, a fixed full glass roof structure, a fixed half glass roof structure or a movable sun structure. For other examples, other types of metal can be used in place of aluminum and a clear plastic can be used in place of glass.

As set forth herein, various embodiments, examples and aspects will be described with reference to details discussed below, and the accompanying drawings will illustrate various embodiments and examples. The following description and drawings are illustrative and are not to be construed as limiting. Numerous specific details are described to provide a thorough understanding of various embodiments and examples. However, in certain instances, well-known or conventional details are not described in order to provide a concise discussion of the embodiments and examples.

### Exemplary Vehicle Roof Structures

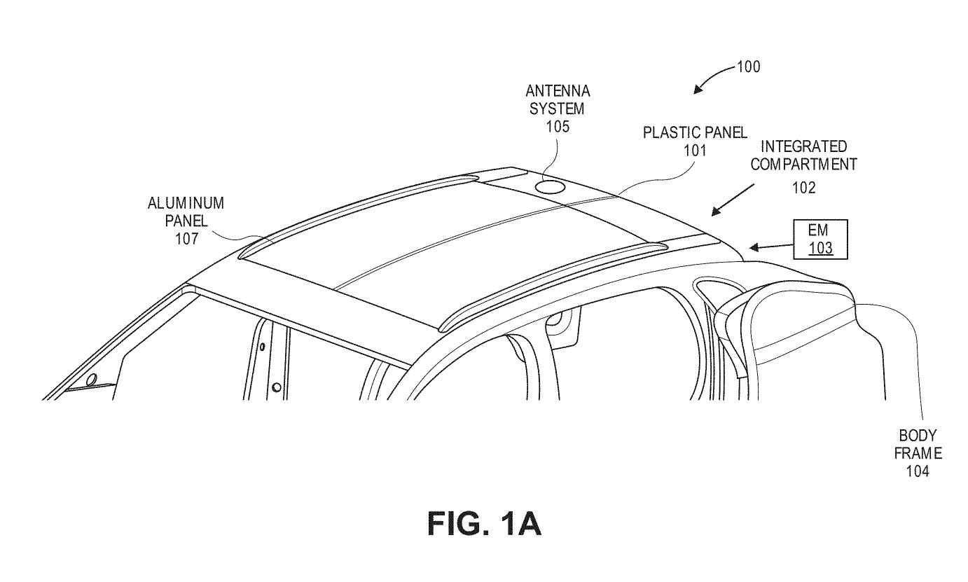

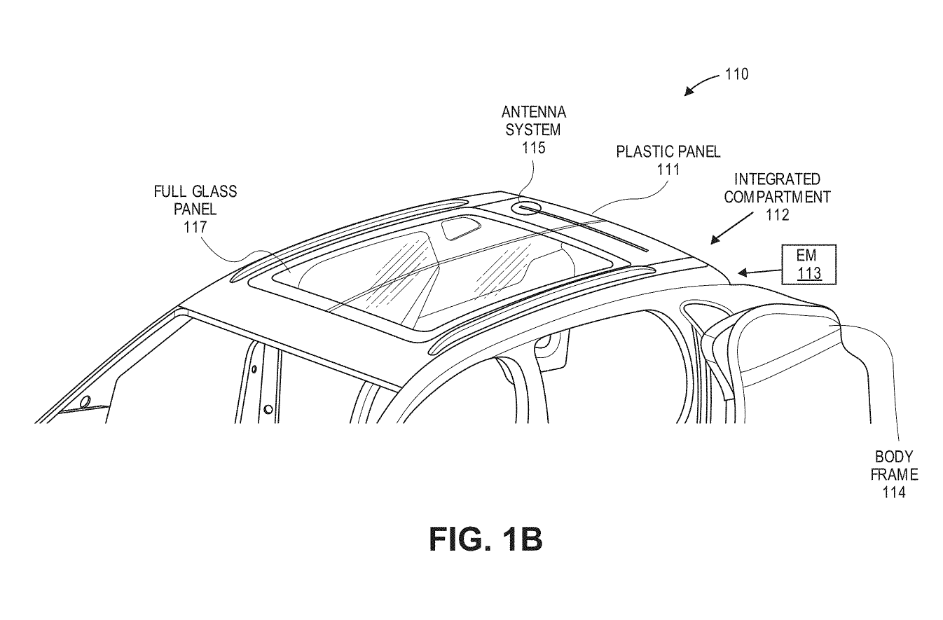

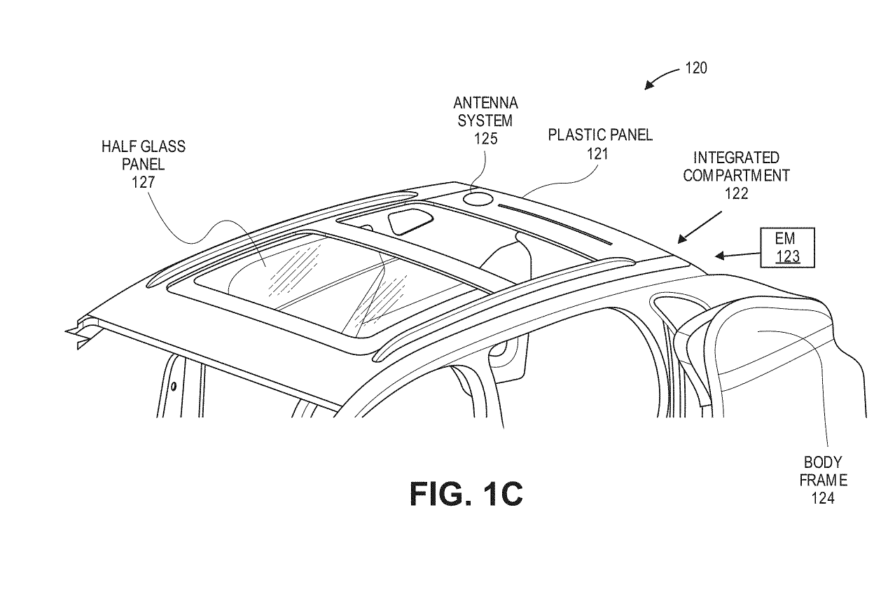

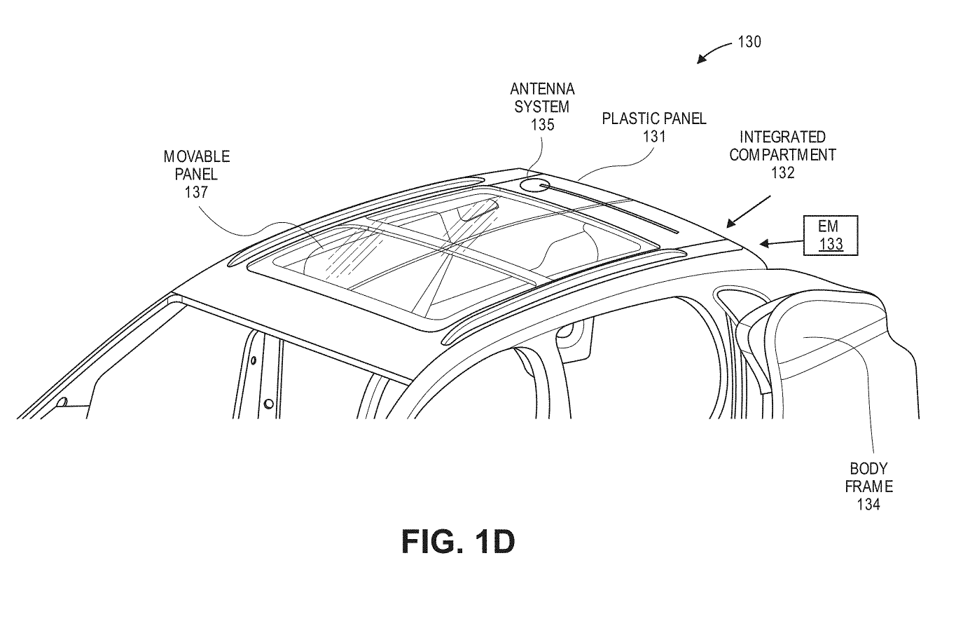

FIGS. 1A-D illustrates exemplary roof structures 110, 110, 120 and 130 with integrated compartments to house one or more electrical modules which can be coupled to antenna system. The exemplary roof structures can be attached to a body frame for any type of vehicles such as electric or non-electric automobiles including self-driving or autonomous automobiles.

Referring to FIG. 1A, an aluminum roof structure 100 is shown connected to a body frame 104. Roof structure 100 includes an aluminum panel 107 and a plastic panel 101 on the top side of roof structure 100. For one example, plastic panel 101 can cover an integrated compartment 102 defined by parts or components of roof structure 100. Within integrated compartment 102, an electrical module (EM) 103 is housed under the plastic panel 101. Although one electrical module and integrated compartment are referred to in FIG. 1A, any number of modules or compartments can be housed within roof structure 100 or integrated compartment 102. Examples of electrical module 103 can include an electrical connectivity module (having one or more modems) to provide connectivity with antenna system 105 which can provide radio frequency (RF), cellular other type of wireless communications. Antenna system 105 can include one or more antennas which can be part of a flat antenna system or shark fin type antenna system attached to plastic panel 101 and coupled to electrical module 103. For one example, antenna system 105 can be embedded in plastic panel 101 or formed on plastic panel 101.

For one example, electrical module 103 is a box that can house a plurality of modems to receive and transmit modulated RF, cellular or other types of wireless signals including WiFi signals using antenna system 105. For one example, electrical module 103 can be an advanced driver assistance systems (ADAS) module which can assist a driver in the driving process and can be configured to operate with a human-machine interface. Within integrated compartment 102 or other integrated compartments, an electrical connectivity module and ADAS module can be housed in roof structure 100. The roof structure can be mechanically fastened or attached to body frame 104 or chemically bonded using a sealant or glue.

Referring to FIG. 1B, a fixed full glass roof structure 110 is shown connected to a body frame 114. Roof structure 110 includes a full glass panel 117 and a plastic panel 111 on the top side of roof structure 110. Plastic panel 111 can cover an integrated compartment 112 defined by parts or components of roof structure 110. Integrated compartment 112 can include multiple compartments to house electrical modules including electrical module 113 under plastic panel 111. Electrical module 113 can include an electrical connectivity module to provide connectivity with antenna system 115 in providing wireless communications. Antenna system 115 can include one or more antennas which can be part of a flat antenna system or shark fin type antenna system attached to plastic panel 111 and coupled to electrical module 113. Antenna system 105 can be embedded in plastic panel 111 or formed on plastic panel 111. Electrical module 113 can be an ADAS module which can assist a driver in the driving process for a vehicle having fixed full glass roof structure 110. For one example, integrated compartment 112 can include an electrical connectivity module and an ADAS module and operate in the same way as described in FIG. 1A.

Referring to FIG. 1C, a half full glass roof structure 120 is shown connected to a body frame 114. Roof structure 120 includes a half glass panel 127 and a plastic panel 121 on the top side of roof structure 120. Plastic panel 121 covers an integrated compartment 122 defined by parts or components of roof structure 120 and attached to antenna system 125. Integrated compartment 122 can include multiple compartments to house electrical modules including electrical module 123 under plastic panel 121. Electrical module 123 can include an electrical connectivity module to provide connectivity with antenna system 125 in providing radio and cellular communications. Antenna system 125 can include one or more antennas which can be part of a flat antenna system or shark fin type antenna system attached to plastic panel 121 and coupled to electrical module 123. Antenna system 125 can be embedded in plastic panel 121 or formed on plastic panel 121. Electrical module 123 can be an ADAS module which can assist a driver in the driving process for a vehicle having half glass roof structure 120. For one example, integrated compartment 122 can include an electrical connectivity module and an ADAS module and operate in the same way as described in FIG. 1A.

Referring to FIG. 1D, a movable sun roof structure 130 is shown connected to a body frame 134. Roof structure 130 includes a movable panel 137 and a plastic panel 131 on the top side of roof structure 130. Plastic panel 131 can covers an integrated compartment 132 defined by parts or components of roof structure 130 and attached to antenna system 135. Integrated compartment 132 can include multiple compartments to house electrical modules including electrical module 133 under plastic panel 131. Electrical module 133 can include an electrical connectivity module to provide connectivity with antenna system 135 in providing radio and cellular communications. Antenna system 135 can include one or more antennas which can be part of a flat antenna system or shark fin type antenna system attached to plastic panel 131 and coupled to electrical module 133. Antenna system 135 can be embedded in plastic panel 131 or formed on plastic panel 131. Electrical module 133 can be an ADAS module which can assist a driver in the driving process for a vehicle having half glass roof structure 130. For one example, integrated compartment 132 can include an electrical connectivity module and an ADAS module and operate in the same way as described in FIG. 1A.

For the examples of FIGS. 1A-1D, the plastic panels (e.g., panels 101, 111, 121, 131) were formed at the back end of the roof structures covering an integrated compartment which can house one or more electric modules. For other examples of roof structures 100, 110, 120 and 130, an integrated compartment can be integrated in the front end of the roof structures which can house an electrical module such as an ADAS module. Thus, the roof structures of FIGS. 1A-1D can have one electrical module integrated into the front end of the roof structure (e.g., an ADAS module) and one electrical module integrated into the back end of the roof structure (e.g., an electrical connectivity module having one or more modems coupled to an antenna system).

### Aluminum Roof Structure Example

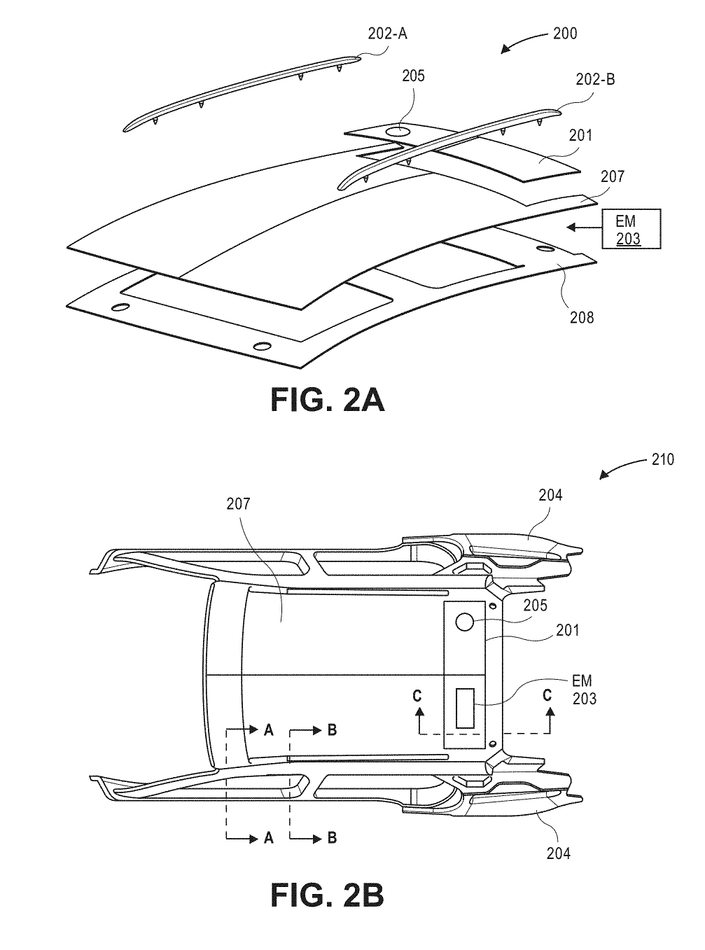

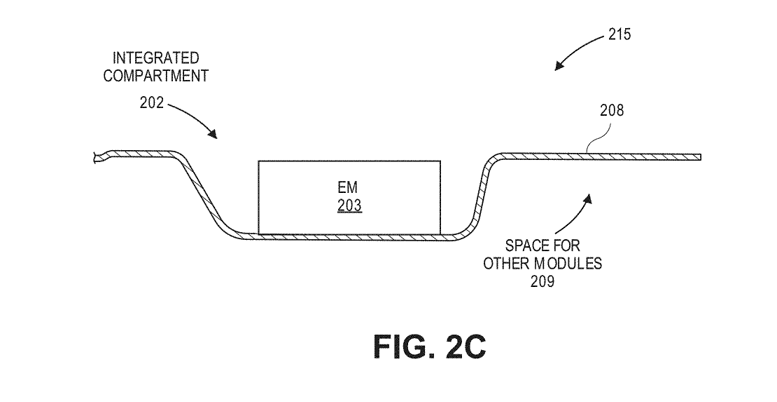

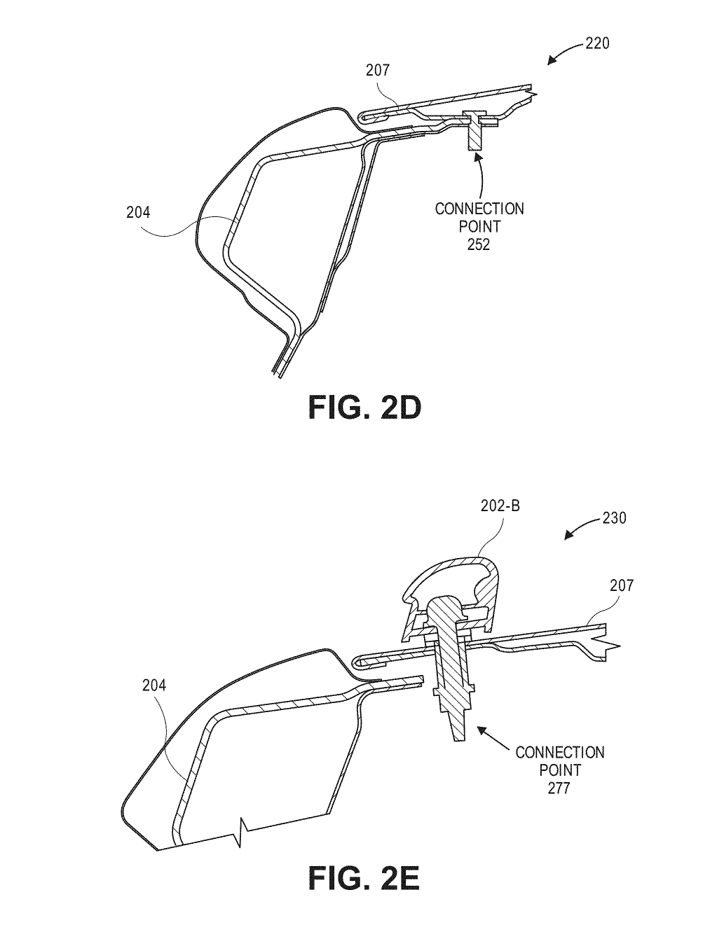

FIG. 2A illustrates exemplary simplistic views of pre-assembled parts including side connectors 202-A and 202-B, plastic panel 201 having an attached antenna system 205, aluminum panel 207, and a bottom panel 208 for aluminum roof structure 200. For one example, the pre-assembled parts can define one or more compartments as described herein to house an electrical module (EM) 203. For one example, EM module 203 can be mounted in the back end of roof structure 200 and, for other examples, an EM module can be mounted in the front end of the roof structure 200 which can have an integrated compartment to house the EM module.

FIG. 2B illustrates one example of a top view 210 of the aluminum roof structure 200 of FIG. 2A attached to body frame 204. Hatch lines C-C, A-A and B-B are drawn to reference the cross-sectional views for FIGS. 2C, 2D and 2E. FIG. 2C illustrates one example of a cross-sectional view 215 taken along the line C-C in FIG. 2B. Referring to FIG. 2C, a bottom panel 208 can be shaped and configured to define integrated compartment 202 to house EM module 203. For one example, bottom panel 208 can also define space for other modules 209 can house other EM modules. EM module 203 can be an electrical connectivity module having one or more modems having outputs coupled to antenna system 205 attached to panel 201. Bottom panel 208 can include one or more layers or panels to define integrated compartment 202.

FIG. 2D illustrates one example of a cross-sectional view 220 taken along the line A-A in FIG. 2B. Referring to FIG. 2D, in one example, a connection point 252 is show as a mechanical fastener connecting aluminum panel 207 to body frame 204. Other types of connection points can be made such as chemical bond or glue. FIG. 2E illustrates one example of a cross-sectional view 230 taken along the line B-B in FIG. 2B. Referring to FIG. 2E, for one example, connection point 277 is shown connecting side connector 202-B, aluminum panel 297 and body frame 204 using a mechanical fastener. For other examples, connection point 277 can be a chemical bonding connection or glue connection.

### Fixed Full Glass Roof Structure Example

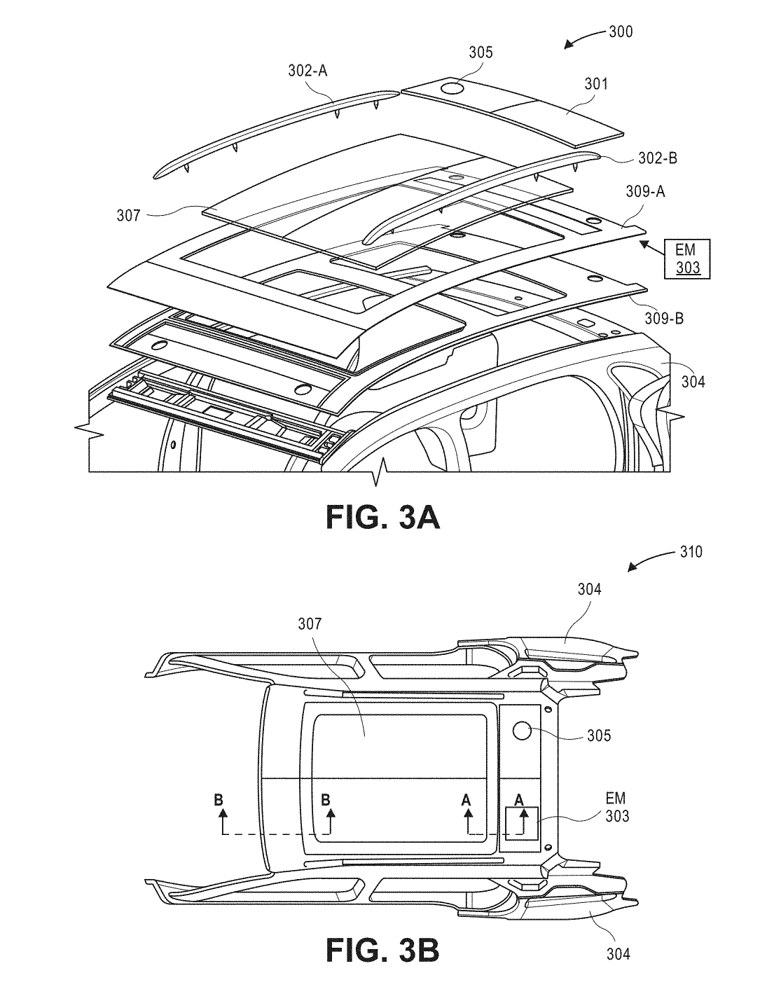

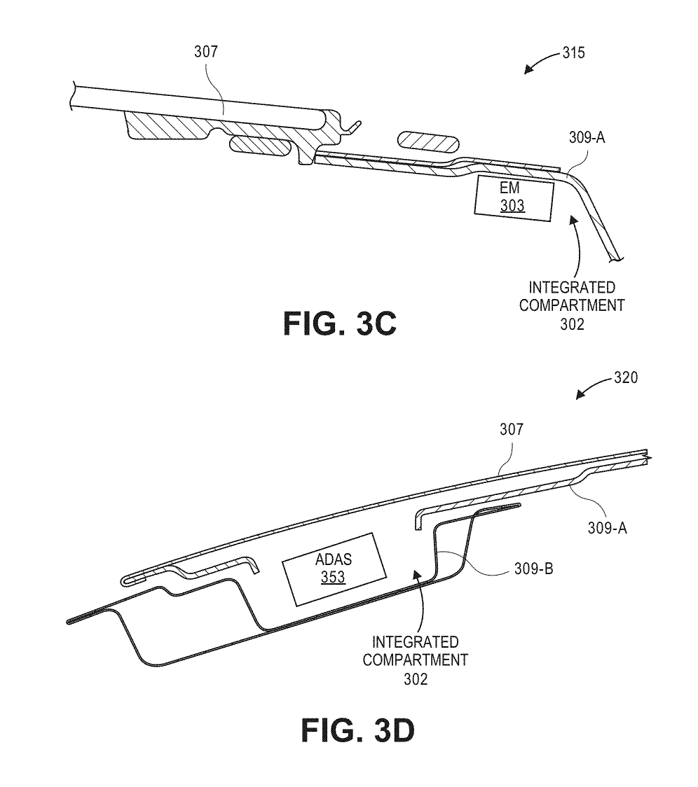

FIG. 3A illustrates exemplary simplistic view of pre-assembled parts including side connectors 302-A and 302-B, plastic panel 301 having an attached antenna system 305, full glass panel 207, top panel 209-A and a bottom panel 209-B for a fixed full glass roof structure 300. For one example, the pre-assembled parts can define one or more integrated compartments as described herein to house electrical module (EM) E03. For one example, EM module 203 can be mounted in the back end of roof structure 300 and, for other examples, an EM module can be mounted in the front end of roof structure which can have an integrated compartment to house the EM module.

FIG. 3B illustrates one example of a top view 310 of the fixed full glass roof structure 300 of FIG. 3A attached to a body frame 304. Hatch lines A-A and B-B are drawn to reference the cross-sectional views for FIGS. 3C and 3D. FIG. 3C illustrates one example of a cross-sectional view 315 taken along the line A-A in FIG. 3B. Referring to FIG. 3C, a top panel 309-A can be shaped and configured to define integrated compartment 302 to house EM module 303. For one example, bottom panel 309-B can also define or assist in defining integrated space 302 to house EM module 303 and full glass panel 307 can assist in defining integrated compartment 302. For one example, EM module 303 can be an electrical connectivity module having one or more modems having outputs coupled to antenna system 305 attached to panel 301. FIG. 3D illustrates one example of a cross-sectional view 320 taken along the line B-B in FIG. 3B. Referring to FIG. 3D, full glass panel 307, top and bottom panels 309-A and 309B can define an integrated compartment 342 at the front end of roof structure 300 to house an ADAS module 353. Other layers or panels can be used to further define integrated compartment 342.

### Fixed Half-Glass Roof Structure Example

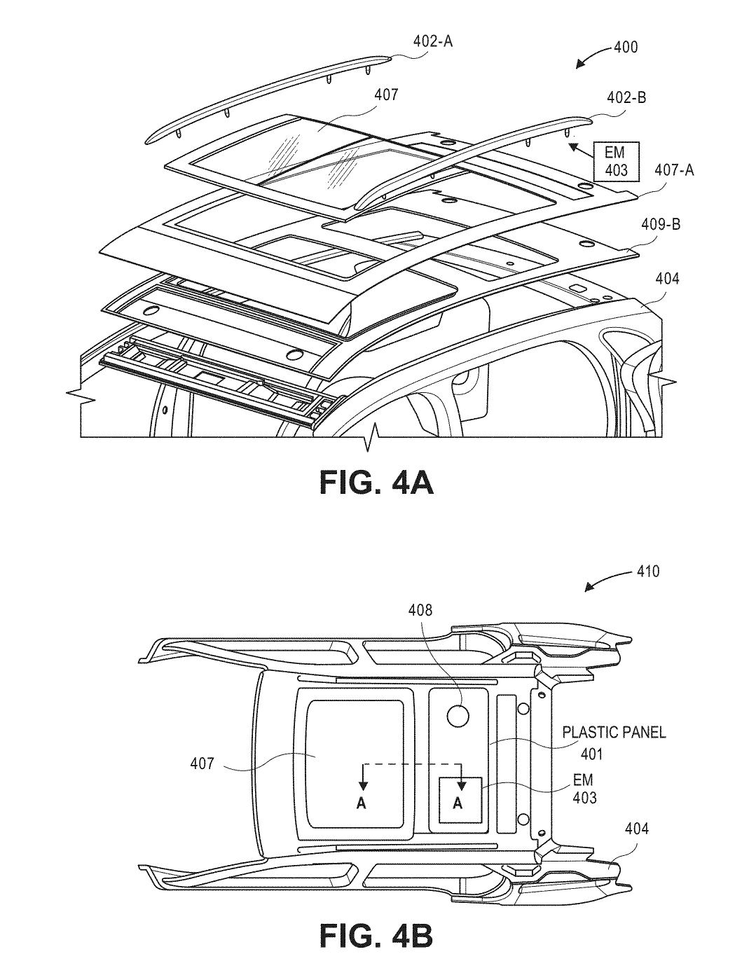

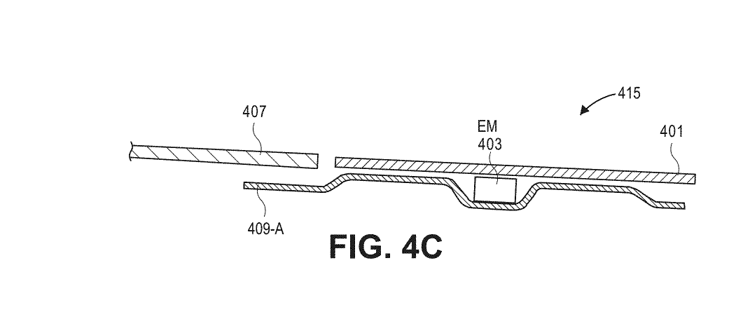

FIG. 4A illustrates exemplary simplistic view of pre-assembled parts including side connectors 402-A and 402-B, half glass panel 407, top panel 409-A and a bottom panel 409-B for a fixed half glass roof structure 400. A plastic panel 401 for roof structure 400 is not shown so as to clearly show the half glass panel 407 of roof structure 400. The pre-assembled parts can define one or more integrated compartments as described herein to house one or more electrical modules such EM module 403.

FIG. 4B illustrates one example of a top view 410 of the fixed half glass roof structure 400 of FIG. 4A attached to a body frame 404. Referring to FIG. 4B, plastic panel 401 is shown having an antenna system 205 attached to the panel and EM module 403 can be housed in an integrated compartment below plastic panel 401. Hatch lines A-A are drawn to reference the cross-sectional view for FIG. 4C. FIG. 4C illustrates one example of a cross-sectional view 415 taken along the line A-A in FIG. 4B. Referring to FIG. 4C, plastic panel 401 and top panel 409-A can be shaped and configured to define an integrated compartment to house EM module 403. Fixed half glass panel 407 can also be used to assist in defining other compartments along with roof structure parts.

### Movable Sun Roof Structure Example

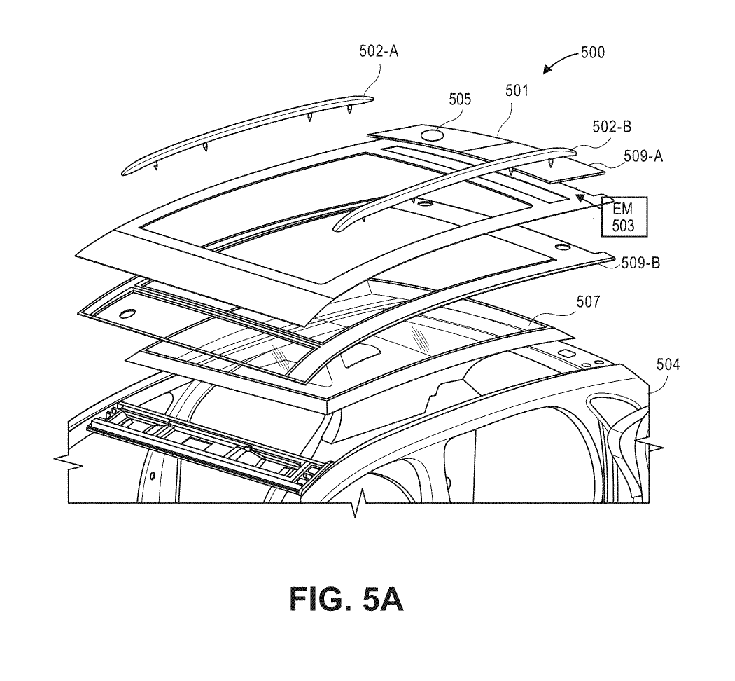

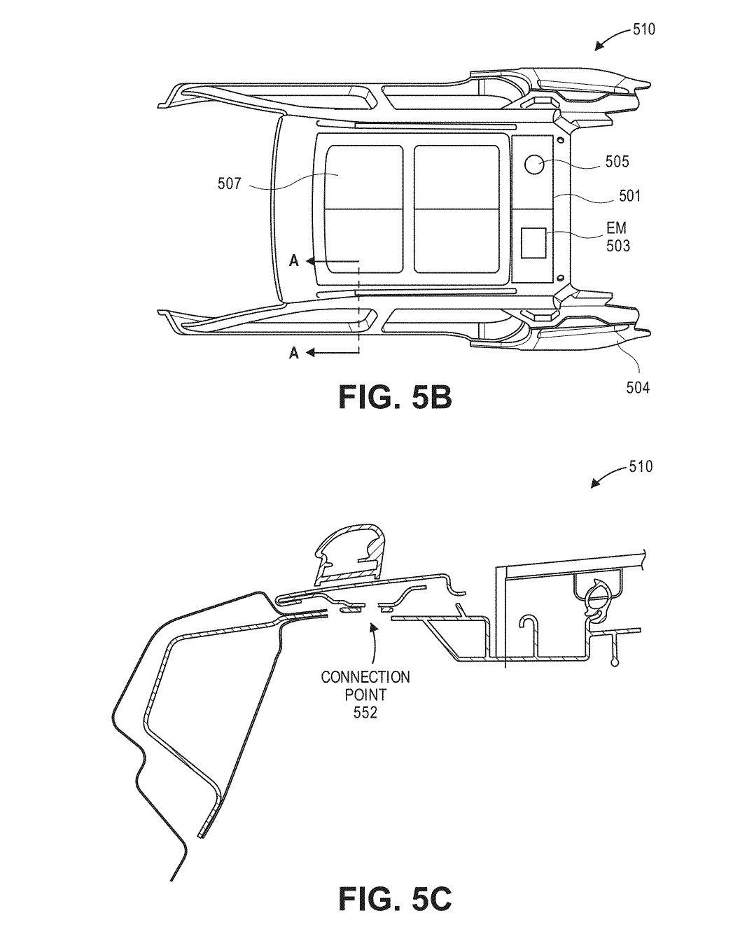

FIG. 5A illustrates exemplary simplistic view of pre-assembled parts including side connectors 502-A and 502-B, movable panel 507, plastic panel 502 having an antenna system 505, top panel 509-A and a bottom panel 509-B for a movable sun roof structure 500. The pre-assembled parts can define one or more integrated compartments as described herein to house one or more electrical modules such EM module 503. FIG. 5B illustrates one example of a top view 510 of the movable sun roof structure 500 of FIG. 5A attached to a body frame 504. Referring to FIG. 5B, plastic panel 501 is shown having an antenna system 505 attached to the panel and EM module 503 can be housed in an integrated compartment below plastic panel 501. Hatch lines A-A are drawn to reference the cross-sectional view for FIG. 5C with a mechanical connection point to fasten the movable panel 507 to body frame 504. Although not shown in FIG. 5C, any number of panels in roof structure 500 can be used to define any number of integrated compartments to house one or more EM modules 503.

### Example Roof Structure Having Electrical Connectivity and ADAS Modules

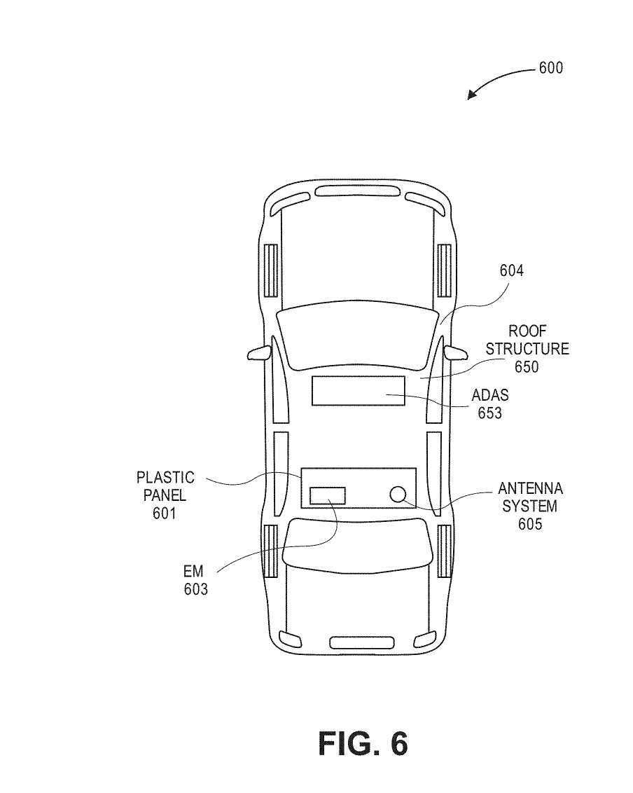

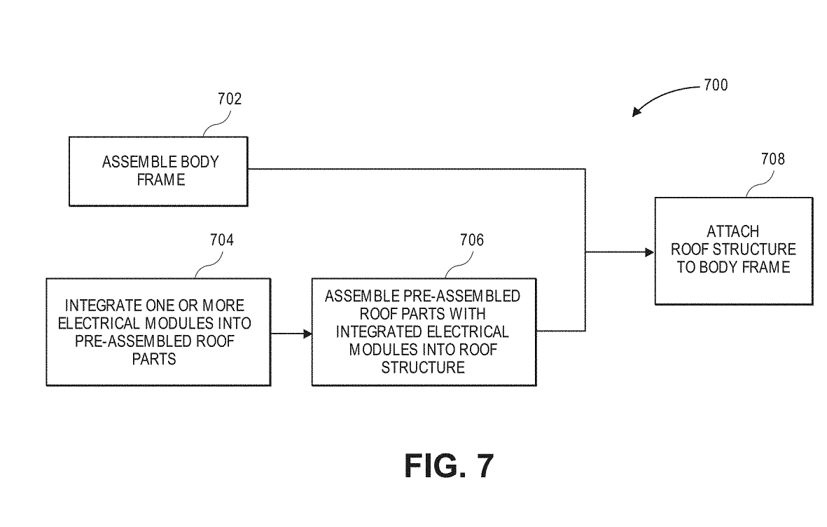

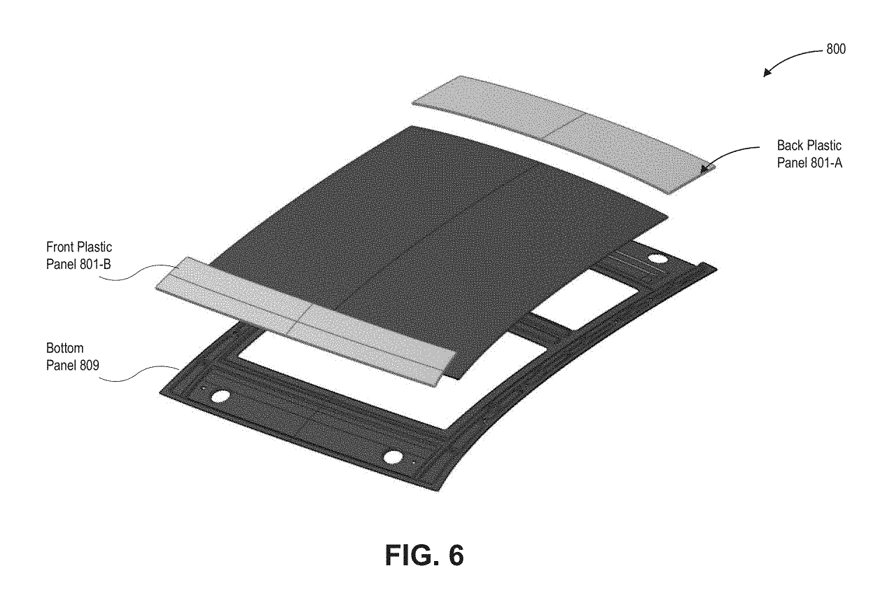

FIG. 6 illustrates one example of an assembled vehicle 600 showing a top view of a roof structure 650 attached to a body frame 604. For one example, the roof structure 650 can be configured to define one or more compartments as described, e.g., in FIGS. 1A-5C, in the roof structure 650 to house any number of electrical modules. For one example, an electrical connectivity module 603 can be mounted in a compartment under plastic panel 601 at the rear end of vehicle 600 and an ADAS module 653 can be mounted in another compartment in the front end of vehicle 600. For one example, antenna system 605 can be attached to plastic panel 601 and, in another example, antenna system 605 can be embedded in plastic panel 601 or formed on plastic panel 601. Vehicle 600 can have any type of roof structure 650 with two or more electrical modules (e.g., modules 603 and 653) such an aluminum roof structure, a fixed full glass roof structure, a fixed half glass roof structure or a movable sun roof structure as described in FIGS. 1A-5C. The different types of roof structures can be assembled separately and attached to a body frame of the vehicle 600 during general assembly.

### Vehicle Assembly Process Example

FIG. 7 illustrates one example of a flow diagram 700 of a process for a vehicle assembly. The process can include a number of steps or sub-steps to implement process blocks 702 through 708. At process block 702, a body frame of a vehicle is assembled (e.g., body frames 104, 114, 124, 134, 204, 304, 404, 504 and 604).

At processing block 704, one or more electrical modules are integrated into pre-assembled roof structure parts defining one or more compartments to house the electrical modules as described in FIGS. 1A-5C. For example, an electrical connectivity module (e.g., 103, 113, 123, 133, 203, 303, 403, 503 and 603) can be integrated into a first compartment defined by the pre-assembled roof structure parts. For another example, an ADAS module (e.g., 653) can be integrated into a second compartment defined by the pre-assembled roof structure parts. For one example, one of the pre-assembled roof structure parts can include a plastic panel (e.g. 101, 111, 121, 131, 201, 301, 401, 501 and 601 in which an antenna system (e.g., 105, 115, 125, 135, 205, 305, 405, 505 and 605) can be attached, embedded or formed on the plastic panel. The antenna system can be coupled to the one or more electrical modules during this processing block.

At processing block 706, the pre-assembled roof structure parts and integrated one or more electrical modules are assembled into a roof structure as described, e.g., in FIGS. 1A-5C. For one example, processing block 704 and 706 are performed separately and independently of assembling the body frame in processing block 702.

At processing block 708, the assembled roof structure is attached to the assembled body frame. This process can be performed during general assembly of the vehicle. In the above process, the assembly and testing of the roof structure can be performed offline and, regardless of the type of roof structure, the roof structure can be seamlessly assembled with the body frame during general assembly of the vehicle. For one example, vehicle 600 in FIG. 6 shows an assembled vehicle assembled by flow diagram 700 having multiple electrical modules integrated into the roof structure 650, e.g., electrical connectivity module 603 under plastic panel at the rear end of vehicle 600 and ADAS module 653 at the front end of vehicle 600. The electrical connectivity module 603 can be coupled to antenna system 605 attached, embedded or on plastic panel 605.

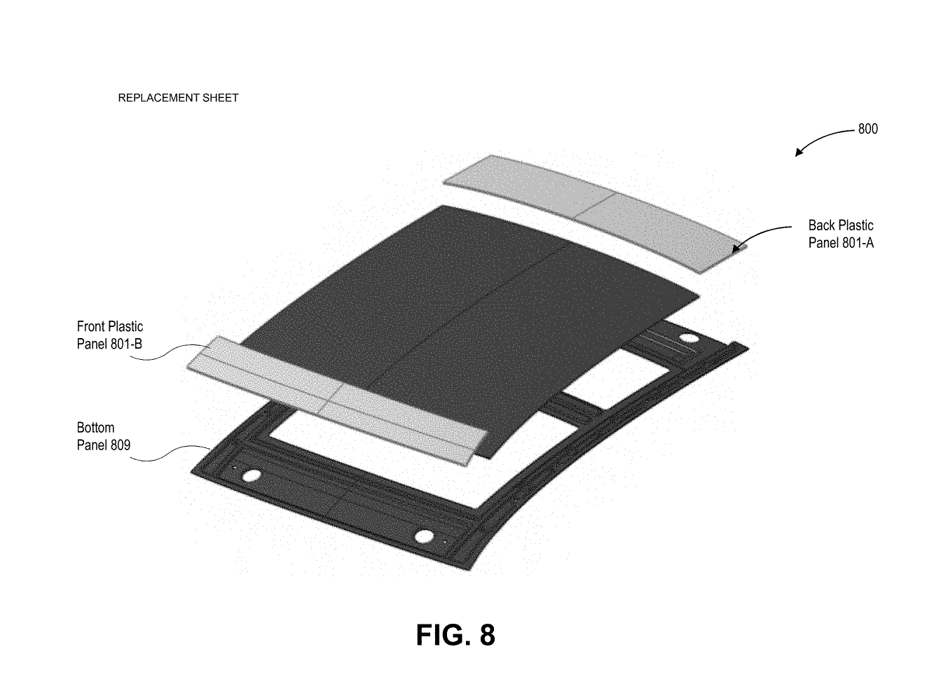

FIG. 8 illustrates another example of pre-assembled parts for roof structure 800 with back plastic panel 801-A and a front plastic panel 801-B and bottom panel 809 below the plastic panels which can form an integrated compartment under the front and back plastic panels 801-A and 801-B to house electrical module or an ADAS module. For one example, bottom panel 809 can be configured or shaped to form the integrated compartment. The front and back plastic panels 801-A and 801-B can be used in any type of roof structure including movable sun roof structures.

In the foregoing specification, the invention has been described with reference to specific exemplary embodiments thereof. It will, however, be evident that various modifications and changes may be made thereto without departing from the broader spirit and scope of disclosed examples and embodiments. The specification and drawings are, accordingly, to be regarded in an illustrative rather than a restrictive sense.

What is claimed is:

1. A vehicle roof structure comprising:
a plurality of pre-assembled components including a plastic panel, the plastic panel to cover a first compartment in the roof-structure; and
an electrical connectivity module housed in the first compartment integrated into the roof-structure below the plastic panel.

2. The vehicle roof structure of claim 1, further comprising:
an antenna system to provide radio or cellular communications, wherein the electrical connectivity module is coupled to the antenna system.

3. The vehicle roof structure of claim 1, wherein the antenna system is attached to the plastic panel.

4. The vehicle roof structure of claim 1, wherein the electrical connectivity module includes a plurality of modems to receive and transmit radio or cellular signals.

5. The vehicle roof structure of claim 1, wherein the roof structure including the electrical connectivity module is attached to a body frame of a vehicle.

6. The vehicle roof structure of claim 1, further comprising a second compartment integrated into the roof structure, the second compartment housing an advanced driver assistance systems (ADAS) module.

7. The vehicle roof structure of claim 1, wherein the roof structure is an aluminum roof structure, a fixed full glass roof structure, a fixed half glass roof structure or a movable sun roof structure.

8. A vehicle comprising:
a body frame; and
a roof structure including one or more electrical modules integrated into one or more compartments defined by the roof structure.

9. The vehicle of claim 8, wherein the one or more electrical modules includes an electrical connectivity module and an advanced driver assistance systems (ADAS) module.

10. The vehicle of claim 9, wherein the ADAS module is mounted in a compartment in the front of the roof structure and the electrical connectivity module is mounted in a compartment in the back of the roof structure.

11. The vehicle of claim 10, wherein the roof structure includes a plastic panel placed above the electrical connectivity module.

12. The vehicle of claim 11, further comprising an antenna system attached to the plastic panel.

13. The vehicle of claim 12, wherein the antenna system is to provide radio or cellular communications and the electrical connectivity module is coupled to the antenna system.

14. The vehicle of claim 8, wherein the roof structure is an aluminum roof structure, a fixed full glass roof structure, a fixed half glass roof structure or a movable sun roof structure.

15. A vehicle assembly method comprising:
assembling a body frame for a vehicle;
integrating one or more electrical modules into pre-assembled roof structure parts defining one or more compartments to house the electrical modules;
attaching the pre-assembled roof structure parts with the electrical modules into a roof structure; and
attaching the roof structure to the assembled body frame of the vehicle.

16. The vehicle assembly method of claim 15, wherein integrating the one or more electrical modules into the pre-assembled roof structure parts is integrated independently of the assembly of the body frame for the vehicle.

17. The vehicle assembly method of claim 15, wherein integrating one or more electrical modules include integrating an electrical connectivity module into the pre-assembled roof structure parts into a first compartment.

18. The vehicle assembly method of claim 16, integrating one or more electrical modules include integrating an advanced driver assistance systems (ADAS) module into a second compartment.

19. The vehicle assembly method of claim 17, further comprising integrating an antenna system into a plastic panel as one of the pre-assembled roof structure parts.

20. The vehicle assembly method of claim 19, further comprising coupling the antenna system to the electrical connectivity module.
